(19) United States
(12) Patent Application Publication
(10) Pub. No.: US 2007/0174324 A1
(43) Pub. Date: Jul. 26, 2007

(54) Mechanism to trap obsolete web page references and auto-correct invalid web page references

(76) Inventors: Sriram M. Palapudi, Santa Clara, CA (US); Maria Savarimuthu Rajakannimariyan, San Jose, CA (US); Ravisankar Shanmugam, San Jose, CA (US); Rainer Wolafka, Bad Soden (DE)

Correspondence Address: IBM CORP. (WIP);c/o WALDER INTELLECTUAL PROPERTY LAW, P.C., P.O. BOX 832745, RICHARDSON, TX, 75083, US

(21) Appl. No.: 11/330,485

(22) Filed: Jan. 12, 2006

(51) Int. Cl. G06F 7/00

(52) U.S. Cl. 707/102

(57) ABSTRACT

A mechanism to trap obsolete web page references and auto-correct invalid Web page references is provided. With the mechanism, Web pages of a Web site are indexed in an indexed data structure having entries that list the references contained in the Web page. A Website reference monitor monitors changes to the Web pages and content referenced by these Web pages. If a change to the Web pages or referenced content is detected, other Web pages in the Web site that reference the modified content or Web pages are identified using the indexed data structure. The identified other Web pages may then be automatically updated. In addition, when a client device requests a Web page, the references in the Web page are checked to determine if they reference obsolete or invalid content and such references are modified to be non-selectable before providing the Web page to the client device.

### BACKGROUND

1. Technical Field

The present application relates generally to an improved data processing system and method. More specifically, the present application is directed to a mechanism for trapping obsolete Web page references and auto-correct invalid Web page references.

2. Description of Related Art

Generally, commercial Websites consist of a large amount of static and dynamic content such as Hypertext Markup Language (HTML) content, pictures, graphics, sound and video files, and Web applications. Due to the rapid and frequent changes to Website content, typically on a daily basis, Websites have to be modified accordingly in order to reflect the most up to date information. Such modifications include changing and relocating the content of the HTML, picture, graphics, audio, and video files, and deleting the old static and/or dynamic files.

Typically, such changes, relocation, and the like, is left up to individuals known as Webmasters. The Webmaster's primary role is to keep Websites up to date and manage the operation of the Website on a daily basis. When changes are to be made to a Website, it is up to the Webmaster to update the HTML, picture, graphics, audio, video files, and the like and to ensure that all references to the modified or relocated content are properly updated.

It can be seen that with rapid and frequent changes to Website content, even with very simple Websites, it may be difficult to completely identify every reference, e.g., hyperlinks and the like, to content that has been changed or relocated. Moreover, at present, web browsers and web servers do not know whether a reference to Website content is obsolete, i.e. no longer accessible by the reference, or invalid, i.e. not the correct content intended to be accessed by use of the reference, before the user of a client device tries to access the content. As a result, when a reference to content that has been changed or relocated is accessed by a user, the result may be an error due to the content no longer being present at the particular location, with the same filename, or the like, identified in the reference. In some instances, such references, after changes to and/or relocating of content files has occurred, may point to the wrong content or out-of-date content, i.e. invalid content. This problem is made even more troublesome with the more complex Websites typically found in today's electronic businesses.

### SUMMARY

In view of the above, it would be beneficial to have a mechanism for identifying obsolete or invalid references to Website or Web page content. It would further be beneficial to have a mechanism for automatically correcting obsolete or invalid references in Web pages of Websites based on the identification of such obsolete or invalid references. Moreover, it would be beneficial to have a mechanism that renders obsolete or invalid references to Website or Web page content non-selectable by users of client devices via their Web browsers. The illustrative embodiments provide such mechanisms.

With the mechanisms of the illustrative embodiments, an indexing mechanism is provided for indexing each Web page of a Website and identifying all references to Website content present in the Web pages of the Website. In particular, an index manager is utilized that scans (i.e., crawls) the code of the Web pages of the entire Website and identifies references to Web page content, e.g., hyperlinks, references to image files, graphics files, sound files, video files, etc. Entries in an indexed data structure for the Website are created for the Web pages with each entry identifying the references present in the corresponding Web page. The crawling of the Website may be performed once to establish an initial indexed data structure that is subsequently maintained up-to-date by real time updates when the Website is modified. Alternatively, or in addition, the crawling of the Website may be performed periodically so as to ensure that the indexed data structure is correct.

The indexed data structure is used to identify obsolete and invalid references to Web content in Web pages of a Website as the Website is modified. The index manager registers the indexed Web pages and their corresponding references with a Website reference monitor that monitors real time modifications to the Website. Such modifications may include, for example, Website content deletion, Website content relocation, Website content renaming, Website content addition, or Web page modifications. The Website reference monitor registers the Websites directory structures and files associated with the references in the Web pages to the operating system's file system so as to obtain real time updates regarding these directory structures and files from the file system.

That is, when a change to a registered directory or file occurs, e.g., the deletion, relocation, renaming or addition of a file or directory, the file system notifies the Website reference monitor of this change. The Website reference monitor may then scan the indexed data structure to identify all references in all Web pages of the Website to the changed file or directory and may update these references accordingly in the code of these other Web pages. In addition, the indexed data structure may be updated to reflect the up-to-date modifications to the Website.

The manner by which these references are updated may be configured according to a preferences profile. For example, preferences may be set that indicate that references to modified Web page content may be automatically corrected in the code of the Web pages. Other preferences may include notifying a Webmaster or other administrator of the modification, providing a report of the references in the Web pages of the Website that need to be updated based on the modification to the Website content, marking obsolete or invalid references so that they are not selectable by a user of a client device, removing obsolete or invalid references in Web pages, and the like.

By way of the index data structure and the Website reference monitor, references to invalid or obsolete Web page content may be identified and automatically corrected so as to avoid having a user access a obsolete reference or the wrong Web page content. In addition, these mechanisms may reduce the network traffic by marking the obsolete or invalid references, or removing the obsolete or invalid references, such that they are not rendered by a Web browser of a client device or otherwise rendered such that they are not selectable by a user. In this way, a user is not able to select the reference to initiate a request for the obsolete or invalid Web page content. As a result, the network traffic associated with requesting obsolete or invalid Web page content is reduced.

In addition to the index manager and Website reference monitor, the illustrative embodiments also provide an obsolete reference correction agent that operates on client device requests for Web pages so as to remove or inactivate obsolete references to Web page content. When a client device sends a request to the Website for a particular Web page, a request handler receives the request and passes the request to the obsolete reference correction agent. The obsolete reference correction agent retrieves the requested Web page and checks the references within the Web page to determine if the references are to live Web page content.

This determination may involve retrieving information from the local file system for those references identifying locally stored Web page content. For references identifying remotely stored Web page content, such as on another server, a request for the Web page content may be sent to the remote system. If the local file system identifies the Web page content associated with the reference to be not present in the file system, or if the request for the Web page content results in an error message being returned, the reference in the requested Web page may be modified so as to make the reference non-selectable by a user of the client device. Such modification may involve modifying the code of the Web page to make the reference non-selectable, to remove the reference from the code altogether, or the like. The modified Web page code may then be sent to the client device so that it may be rendered on the client device via the client device's Web browser.

In one illustrative embodiment, a computer program product comprising a computer useable medium having a computer readable program is provided. The computer readable program, when executed on a computing device, causes the computing device to generate an indexed data structure identifying Web pages of the Website and references to content that are present in the Web pages of the Website. The computer readable program further may cause the computing device to receive a modification to content of the Website, search the indexed data structure to identify one or more Web pages of the Website that contain references to the modified content of the Website, and perform at least one operation based on the identification of the one or more Web pages of the Website that contain references to the modified content. The references to content may comprise one or more of hyperlinks, uniform resource locators (URLs), references to image files, references to graphics files, references to sound files, or references to video files.

The at least one operation may facilitate updating of the references to the modified content in the identified one or more Web pages of the Website. For example, the at least one operation may comprise automatically updating code of the identified one or more Web pages to change a reference to the modified content. The at least one operation may also comprise reporting the identified one or more Web pages having references to the modified content to an administrator. Moreover, the at least one operation may comprise marking the references to the modified content in the identified one or more Web pages such that they are not rendered by Web browsers of client devices in a manner that is selectable by a user.

The computer readable program may cause the computing device to perform at least one operation based on the identification of the one or more Web pages of the Website that contain references to the modified content by retrieving a preferences profile identifying the at least one operation that is to be performed in response to an identification of one or more Web pages containing references to modified content and performing the at least one operation based on the at least one operation identified in the preferences profile. The computer readable program may cause the computing device to generate an indexed data structure by searching each Web page of the Website for references to content contained in each Web page and generating an entry in the indexed data structure for each Web page of the Website, wherein the entry is indexed by an identifier of the Web page and contains a listing of each reference to content contained in the corresponding Web page.

The computer readable program may further cause the computing device to register the indexed data structure with a Website reference monitor and parse the indexed data structure to identify references to content identified in the indexed data structure. Moreover, the computer readable program may also cause the computing device to generate a monitor list comprising a list of the references to content identified in the indexed data structure that are to be monitored. The modification to content of the Website may be received based on a modification to content of the Website matching an entry in the monitor list.

The computer readable program may further cause the computing device to register the monitor list with a file system of a server computing device hosting the Website. The file system may notify the Website reference monitor of modifications to content corresponding to the references to content listed in the monitor list.

The computer readable program may further cause the computing device to update the indexed data structure based on results of performing the at least one operation. The computer readable program may cause the computing device to receive a request for a Web page from a client device and search the indexed data structure for an entry corresponding to the requested Web page. The computer readable program may also cause the computing device to check references to content identified in the entry of the indexed data structure corresponding to the requested Web page to identify one or more references to obsolete or invalid content, modify the one or more references to obsolete or invalid content in code of the requested Web page to generate modified code for the requested Web page, and provide the modified code for the request Web page to the client device.

The computer readable program may cause the computing device to check references to content identified in the entry of the indexed data structure by retrieving information, from a file system of a server computing device hosting the Web page, for those references to content that identify locally stored Web page content. Moreover, requests may be sent to remotely located computing devices hosting content associated with those references to content that identify remotely stored Web page content.

The computer readable program may cause the computing device to identify a reference to content to be a reference to obsolete or invalid content if the file system identifies the Web page content associated with the reference to be not present in a local storage system of the server computing device and registered with the file system or if a request for the Web page content corresponding to the reference sent to a remote computing device results in an error message being returned.

In another illustrative embodiment, a system is provided for updating a Website. The system may comprise a processor and a memory coupled to the processor. The memory may contain instructions that, when executed by the processor, implement an index manager and a Website reference monitor. The index manager may generate an indexed data structure identifying Web pages of the Website and references to content that are present in the Web pages of the Website. The Website reference monitor may receive a modification to content of the Website, search the indexed data structure to identify one or more Web pages of the Website that contain references to the modified content of the Website, and perform at least one operation based on the identification of the one or more Web pages of the Website that contain references to the modified content. The at least one operation may facilitate updating of the references to the modified content in the identified one or more Web pages of the Website.

For example, the at least one operation may comprise automatically updating code of the identified one or more Web pages to change a reference to the modified content. The at least one operation may also comprise reporting the identified one or more Web pages having references to the modified content to an administrator. Moreover, the at least one operation may comprise marking the references to the modified content in the identified one or more Web pages such that they are not rendered by Web browsers of client devices in a manner that is selectable by a user.

The Website reference monitor may perform at least one operation based on the identification of the one or more Web pages of the Website that contain references to the modified content by retrieving a preferences profile identifying the at least one operation that is to be performed in response to an identification of one or more Web pages containing references to modified content. The Website reference monitor may perform the at least one operation based on the at least one operation identified in the preferences profile.

The index manager may generate an indexed data structure by searching each Web page of the Website for references to content contained in each Web page and generating an entry in the indexed data structure for each Web page of the Website. The entry may be indexed by an identifier of the Web page and may contain a listing of each reference to content contained in the corresponding Web page. The references to content may comprise one or more of hyperlinks, uniform resource locators (URLs), references to image files, references to graphics files, references to sound files, or references to video files.

The index manager may register the indexed data structure with a Website reference monitor. The Website reference monitor may parse the indexed data structure to identify references to content identified in the indexed data structure and generate a monitor list comprising a list of the references to content identified in the indexed data structure that are to be monitored. The modification to content of the Website may be received based on a modification to content of the Website matching an entry in the monitor list.

The Website reference monitor may register the monitor list with a file system of a server computing device hosting the Website. The file system may notify the Website reference monitor of modifications to content corresponding to the references to content listed in the monitor list. The index manager may update the indexed data structure based on results of performing the at least one operation.

The instructions in the memory may further implement a obsolete/invalid reference identification and correction engine. The obsolete/invalid reference identification and correction engine may receive a request for a Web page from a client device and search the indexed data structure for an entry corresponding to the requested Web page. The obsolete/invalid reference identification and correction engine may further check references to content identified in the entry of the indexed data structure corresponding to the requested Web page to identify one or more references to obsolete or invalid content, modify the one or more references to obsolete or invalid content in code of the requested Web page to generate modified code for the requested Web page, and provide the modified code for the request Web page to the client device.

The obsolete/invalid reference identification and correction engine may check references to content identified in the entry of the indexed data structure by retrieving information, from a file system of a server computing device hosting the Web page, for those references to content that identify locally stored Web page content and send requests to remotely located computing devices hosting content associated with those references to content that identify remotely stored Web page content. The obsolete/invalid reference identification and correction engine may identify a reference to content to be a reference to obsolete or invalid content if the file system identifies the Web page content associated with the reference to be not present in a local storage system of the server computing device and registered with the file system or if a request for the Web page content corresponding to the reference sent to a remote computing device results in an error message being returned.

In a further illustrative embodiment, a method, in a data processing system, for updating a Website is provided. The method may comprise generating an indexed data structure identifying Web pages of the Website and references to content that are present in the Web pages of the Website. The method may further comprise receiving a modification to content of the Website, searching the indexed data structure to identify one or more Web pages of the Website that contain references to the modified content of the Website, and performing at least one operation based on the identification of the one or more Web pages of the Website that contain references to the modified content. The at least one operation may facilitate updating of the references to the modified content in the identified one or more Web pages of the Website.

The at least one operation may comprise at least one of automatically updating code of the identified one or more Web pages to change a reference to the modified content, reporting the identified one or more Web pages having references to the modified content to an administrator, or marking the references to the modified content in the identified one or more Web pages such that they are not rendered by Web browsers of client devices in a manner that is selectable by a user.

The performing of at least one operation based on the identification of the one or more Web pages of the Website that contain references to the modified content may comprise retrieving a preferences profile identifying the at least one operation that is to be performed in response to an identification of one or more Web pages containing references to modified content and performing the at least one operation based on the at least one operation identified in the preferences profile. The generating of an indexed data structure may comprise searching each Web page of the Website for references to content contained in each Web page and generating an entry in the indexed data structure for each Web page of the Website. The entry may be indexed by an identifier of the Web page and contains a listing of each reference to content contained in the corresponding Web page.

The method may further comprise registering the indexed data structure with a Website reference monitor and parsing the indexed data structure to identify references to content identified in the indexed data structure. The method may also comprise generating a monitor list comprising a list of the references to content identified in the indexed data structure that are to be monitored. The modification to content of the Website may be received based on a modification to content of the Website matching an entry in the monitor list.

The method may comprise registering the monitor list with a file system of a server computing device hosting the Website. The file system may notify the Website reference monitor of modifications to content corresponding to the references to content listed in the monitor list. The method may further comprise updating the indexed data structure based on results of performing the at least one operation. Further, the method may comprise receiving a request for a Web page from a client device, searching the indexed data structure for an entry corresponding to the requested Web page, and checking references to content identified in the entry of the indexed data structure corresponding to the requested Web page to identify one or more references to obsolete or invalid content. The method may also comprise modifying the one or more references to obsolete or invalid content in code of the requested Web page to generate modified code for the requested Web page and providing the modified code for the request Web page to the client device.

The checking of references to content identified in the entry of the indexed data structure may comprise retrieving information, from a file system of a server computing device hosting the Web page, for those references to content that identify locally stored Web page content. The checking of references may further comprise sending requests to remotely located computing devices hosting content associated with those references to content that identify remotely stored Web page content.

These and other features and advantages of the present invention will be described in, or will become apparent to those of ordinary skill in the art in view of, the following detailed description of the exemplary embodiments of the present invention.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram of a distributed network data processing system in which exemplary aspects of the illustrative embodiments may be implemented;

FIG. 2 is an exemplary block diagram of a server data processing system in which exemplary aspects of the illustrative embodiments may be implemented;

FIG. 3 is an exemplary block diagram of a client data processing system in which exemplary aspects of the illustrative embodiments may be implemented;

FIG. 4 is an exemplary diagram illustrating a data flow between the primary operational elements of one illustrative embodiment;

FIG. 5 is an exemplary diagram illustrating an index structure in accordance with one illustrative embodiment;

FIG. 6 is a flowchart outlining an exemplary operation for scanning websites for obsolete Web page references and for auto-correcting Web page references in accordance with one illustrative embodiment; and

FIG. 7 is a flowchart outlining an exemplary operation for handling a client request in accordance with one illustrative embodiment.

### DETAILED DESCRIPTION OF THE PREFERRED EMBODIMENTS

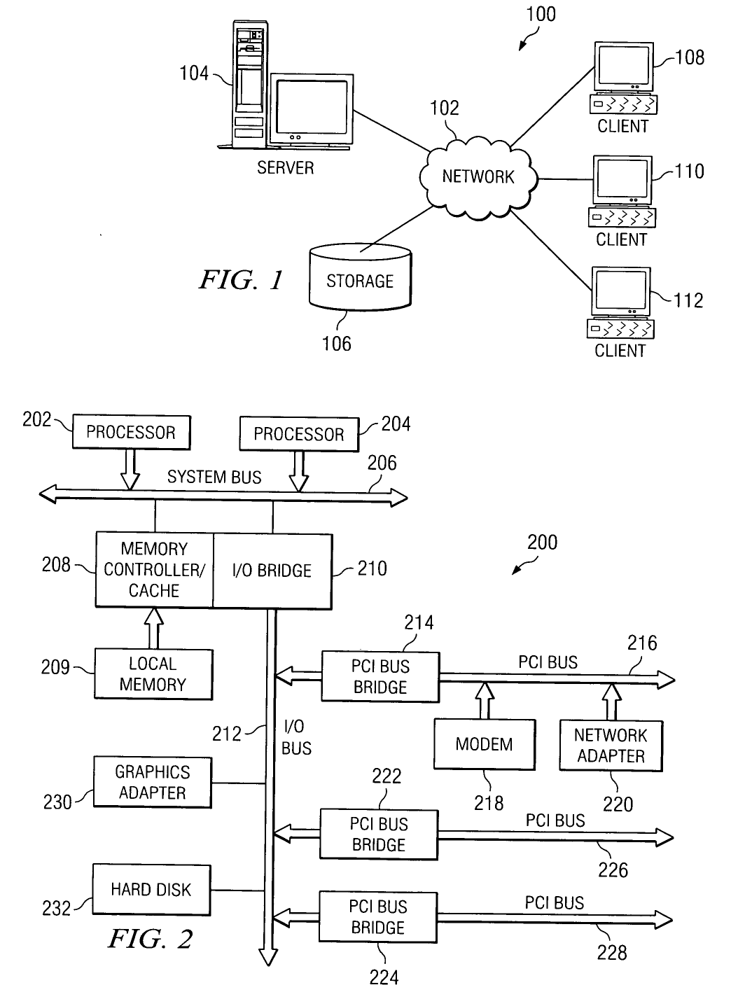

The illustrative embodiments provide a mechanism for identifying and automatically correcting obsolete and invalid references in Web pages. As such, the mechanisms of the illustrative embodiments are especially well suited for implementation in a distributed network data processing system in which a plurality of computing devices communicate with one another via one or more networks. FIGS. 1-3 hereafter are provided as examples of data processing environments and devices in which the exemplary aspects of the illustrative embodiments may be implemented. FIGS. 1-3 are only exemplary and are not intended to state or imply any limitation with regard to the types of environments or data processing systems in which the present invention may be implemented. Many modifications to the architectures illustrated in FIGS. 1-3 may be made without departing from the spirit and scope of the present invention.

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O Bus Bridge 210 is connected to system bus 206 and provides an interface to I/O bus 212. Memory controller/cache 208 and I/O Bus Bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

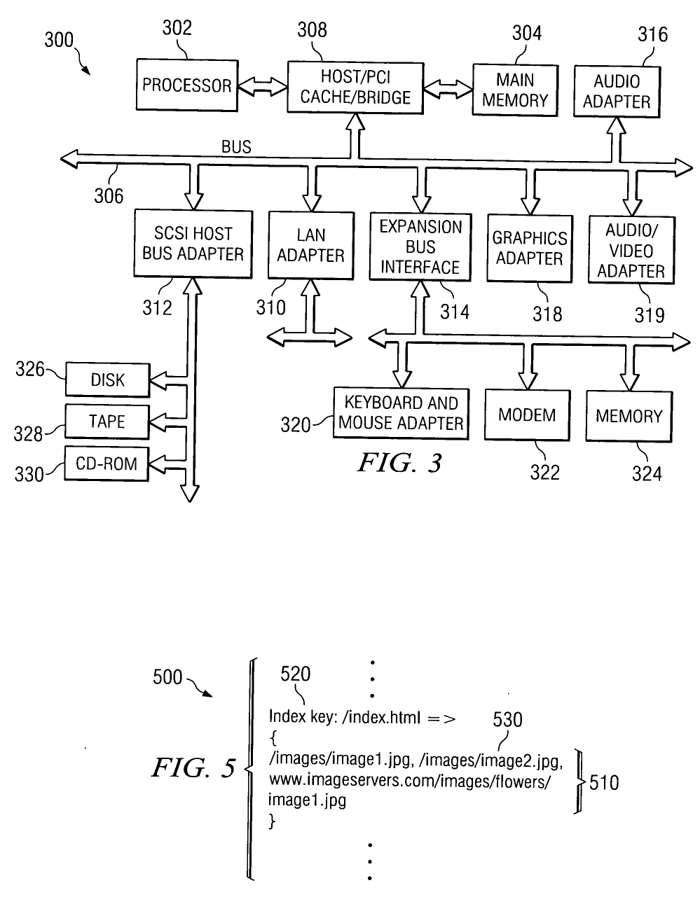

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI Bridge 308. PCI Bridge 308 also may include an integrated memory controller and cache memory for processor 302. Additional connections to PCI local bus 306 may be made through direct component interconnection or through add-in boards.

In the depicted example, local area network (LAN) adapter 310, small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

Referring again to FIG. 1, with the illustrative embodiments, server 104 provides one or more Websites that may be accessed by client devices 108-112. In addition, server 104 includes a obsolete/invalid reference identification and correction engine that operates to monitor Websites to identify obsolete and/or invalid references to Web page content and automatically correct such references prior to Web pages being sent to client devices for rendering by client device Web browsers. In this way, frustration on the part of users of client devices when accessing obsolete and invalid references is reduced. Moreover, network traffic for retrieving obsolete or invalid Web page content is reduced.

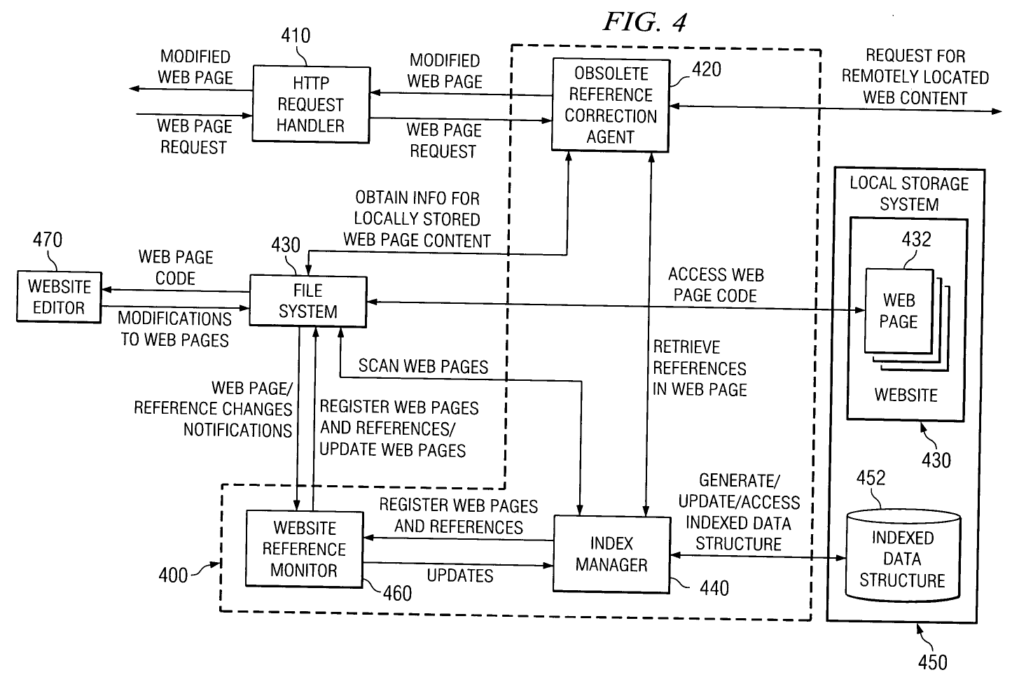

FIG. 4 is an exemplary diagram illustrating a data flow between the primary operational elements of a obsolete/invalid reference identification and correction engine in accordance with one illustrative embodiment. In the illustrative embodiment, the operational elements shown in FIG. 4 are provided as part of a server computing device that hosts one or more Websites. For example, the server computing device may be server 104 in FIG. 1 that provides Website Web page content to client devices 108-112.

As shown in FIG. 4, a obsolete/invalid reference identification and correction engine 400 includes a obsolete reference correction agent 420, an index manager 440, and a website reference monitor 460. The elements 420, 440 and 460 interfaces with a file system 480 of the server computing device to obtain access to Web pages 432 of Website 430 stored in local storage system 450. The index manager 440 further interfaces with an index data structure 452 stored in the local storage system 450. Obsolete reference correction agent 420 further interfaces with HTTP request handler 410 to handle requests for Web pages from client computing devices.

The obsolete/invalid reference identification and correction engine 400 (hereafter referred to as the “reference engine”) has two main modes of operation. In a first mode of operation, the reference engine 400 monitors modifications to a Website, such as through Website editor 470, in order to identify obsolete/invalid references to Web page content and automatically correct such references. In a second mode of operation, the reference engine 400 operates on requests from client devices for Web pages so as to identify obsolete references in the requested Web pages and rendering these obsolete references non-selectable prior to providing the Web pages to the client devices. Each of these modes of operation will now be described with reference to FIG. 4.

In both modes of operation, the reference engine 400 uses an indexed data structure 452 corresponding to the Website 430 for identifying references present in the Web pages 432 that make up the Website 430. This indexed data structure 452 is generated and maintained up-to-date by the index manager 440.

The index manager 440 indexes each Web page of a Website and identifies all references to Website content present in the Web pages 432 of the Website 430. In particular, an index manager 440 scans (i.e., crawls) the code of the Web pages 432 of the entire Website 430 and identifies references to Web page content, e.g., hyperlinks, references to image files, graphics files, sound files, video files, etc. For example, the index manager 440 looks at the markup language code, e.g., HyperText Markup Language (HTML), for the Web pages 432 and, based on HTML tags, recognizable HTML code terms, or the like, identifies hyperlinks, file references, and the like, in the markup language code of the Web pages 432. In one illustrative embodiment, references are provided as Uniform Resource Locators (URLs) and the index manager 440 searches the code of the Web pages 432 for URLs.

Based on the results of the search of a Web page in the Web pages 432 of the Website 430, an entry for the Web page is added to the indexed data structure 452. The entry in the indexed data structure 452 is indexed by the Web page reference, e.g., the URL of the Web page, and identifies the references present in the corresponding Web page. Other indexing mechanisms may be used as well, including indexed hash tables, such as for secure Web sites, and the like, without departing from the spirit and scope of the present invention. This searching, or crawling, of a Web page is repeated for each Web page in the plurality of Web pages 432 that together comprise the Website 430 such that an indexed data structure 452 for the entire Website 430 is generated. As a result, the indexed data structure 452 will have a separate entry for each Web page in the Website 430 and each entry will identify what Web content references are present in the code of the corresponding Web page.

The searching or crawling of the Website 430 may be performed once, such as upon deployment of the Website 430, to establish an initial indexed data structure 452 that is subsequently maintained up-to-date by real time updates when the Website 430 is modified, as discussed in greater detail hereafter. Alternatively, or in addition, the searching or crawling of the Website 430 may be performed periodically so as to ensure that the indexed data structure 452 is correct and was not inadvertently corrupted or otherwise not kept up-to-date.

The indexed data structure 452 is used to identify obsolete and invalid references to Web content in Web pages of a Website as the Website is modified. Once the index manager 440 generates the indexed data structure 452, the index manager 440 registers the indexed Web pages and their corresponding references with the Website reference monitor 460. Essentially, the indexed data structure 452 is provided to the Website reference monitor 460 which parses the indexed data structure 452 and identifies which files are to be monitored by the Website reference monitor 460. The identification of these files is then added to a monitor list maintained by the Website reference monitor 460. The monitor list is registered with the file system 480 which provides notifications of modifications to the Website reference monitor 460 when any of the files referenced in the monitor list are modified, i.e. deleted, renamed, relocated, new file references added to these files, or the like.

Notifications of modifications to files are provided by the file system 480 to the Website reference monitor 460. The file system 480 informs the Website reference monitor 460, through standard file system notification mechanisms, of the particular file that is modified and the nature of the modification, e.g., deletion, renaming, relocation, addition, etc. Based on the notification, the Website reference monitor 460 may search the indexed data structure 452 for the references to the file that was modified. In this way, the Website reference monitor 460 may identify which Web pages 432 of the Website 430 need to be modified based on the modifications to the file.

For example, a user of a Website editor 470 may access a Web page in the set of Web pages 432 and modify it. In the process, the Web page 432 may be stored in a different location of the local storage system 450, i.e. at a different hyperlink location. Thus, the old hyperlinks to the Web page in other Web pages 432 of the Website 430 will either be obsolete (not have an associated Web page file at the location specified by the hyperlink) or may reference the old, invalid, version of the Web page. Accordingly, these hyperlinks in the other Web pages 432 must be updated to reference the new, modified, version of the Web page at the new location.

The modification performed by the user of the Website editor 470 is reported by the file system 480 to the Website reference monitor 460 and indicates both the file modified and the nature of the modification, e.g., the new location of the modified file in the above example. The Website reference monitor 460 searches all entries of the indexed data structure 452, via the index manager 440, to identify all references to the file that was modified. The references to the modified file may be quickly and easily identified by virtue of the indexed data structure since each entry in the indexed data structure identifies the references included in the Web page associated with the entry. Thus, by searching each entry, all of the references to files, Web pages, and the like, may be identified for the entire Website 430.

Based on the results of the search, one or more of a plurality of operations may be performed. These operations may include automatically updating the references in the other Web pages 432, notifying a Webmaster or other administrator of the Web pages that need to be updated along with the identifier of the file that was modified and the nature of the modification, marking the references in the other Web pages as being invalid or obsolete depending upon the nature of the modification such that they are not rendered by Web browsers in a manner that is selectable by a user, and the like. Such marking of references may be performed, for example, by inserting appropriate tags into the code of the Web pages that, when interpreted by a Web browser, cause the Web browser to render the reference in a non-selectable manner, such as by graying out the reference, removing the hyperlink aspect of the reference and leaving it as text only, or the like.

The manner by which these references are updated may be configured according to a preferences profile stored in the Website reference monitor 460 which is modifiable by a Website operator, owner, or the like. For example, preferences may be set that indicate that references to modified Web page content, e.g., files, directories, or the like, may be automatically corrected in the code of the Web pages. Other preferences may include notifying a Webmaster or other administrator of the modification, providing a report of the references in the Web pages of the Website that need to be updated based on the modification to the Website content, marking obsolete or invalid references so that they are not selectable by a user of a client device, removing obsolete or invalid references in Web pages, and the like.

If the other Web pages 432 are to be modified such that the references to the modified files are updated, then the Website reference monitor 460 edits the code of the Web pages 432 to change references to the old, obsolete, or invalid version of the file. The references are updated based on the nature of the modification performed to the file. For example, if the file is modified and relocated, then the references are updated to reference the new location of the modified file. If the file is modified and renamed, then the references to the file are updated to refer to the new renamed file. If the file is deleted, then the references to the file in the Web pages 432 is removed or marked as obsolete or invalid.

Based on the updates to the actual code of the Web pages 432 that include references to the file that was modified, the Website reference monitor 460 informs the index manager 440 of the Web pages 432 that were updated and the manner by which they were updated, e.g., the changes to the file names, the changes to the storage locations, the removal of a reference to a file, the addition of a reference to a file, and the like. Based on the update information sent from the Website reference monitor 460 to the index manager 440, the index manager 440 updates the entries in the index data structure 452 for the Web pages 432 that were updated. In this way, the indexed data structure 452 is automatically kept up-to-date as modifications to the Website 430 are made by a user of the Website editor 470. Furthermore, references to the modified files of a Website 430 are automatically updated throughout the Website 430 so as to eliminate obsolete or invalid references.

It should be noted that, in addition to detecting modifications to existing files, directories, Web pages, and the like, the file system 480 may further notify the Website reference monitor of additions to the Website 430. For example, if a new Web page is generated, new files or directories are generated, and added to the Website, such additions will be notified to the Website reference monitor 460. Typically, to integrate such new files, directories, or Web pages into the Website 430, existing Web pages 432 of the Website 430 will need to be modified to include a reference to these new files, directories, or Web pages and thus, the new elements may be integrated into the indexed data structure at this time. Alternatively, the file system 480 may inform the Website reference monitor 460 of the generation of these new elements when they are created, even though they are not part of the registered list of Web pages and references yet, such that they may be integrated into the indexed data structure and registered with the Website reference monitor 460 and file system 480.

In addition to the index manager 440 and Website reference monitor 460, the obsolete/invalid reference identification and correction engine 400 of the illustrative embodiments also provides a obsolete reference correction agent 420 that, in the second mode of operation, operates on client device requests for Web pages so as to remove or inactivate obsolete references to Web page content. When a client device, such as client device 490, sends a request to the Website 430 for a particular Web page 432, the request handler 410 receives the request and passes the request to the obsolete reference correction agent 420. The obsolete reference correction agent 420 retrieves the requested Web page 432 via the file system 480 and information for the requested Web page 432 from a corresponding entry in the indexed data structure 452. Based on the information retrieved from the indexed data structure 452, the obsolete reference correction agent 420 checks the references within the Web page 432 to determine if the references are to live Web page content, i.e. existing and valid files in the local storage system 450.

This determination may involve retrieving information from the local file system 480 for those references identifying locally stored Web page content, e.g., files in the local storage system 450. For references identifying remotely stored Web page content, such as files on another server, a request for the Web page content may be sent to the remote system. If the local file system 480 identifies the Web page content associated with the reference to be not present in the local storage system 450 and registered with file system 480, or if the request for the Web page content sent to the remote system results in an error message being returned, the reference in the requested Web page may be modified so as to make the reference non-selectable by a user of the client device. For example, the obsolete reference correction agent 420 may modify the code of the Web page by inserting an appropriate tag in the code of the Web page that causes a Web browser of the client device 490 to render the reference in a non-selectable manner, e.g., rendering the reference in a “grayed-out” manner and removing the selectable hyperlink such that the reference is provided as text only. Alternatively, the reference may be removed from the code altogether. The modified Web page code may then be sent, by the obsolete reference correction agent 420, to the client device 490 via the request handler 410 so that it may be rendered on the client device via the client device's Web browser.

FIG. 5 is an exemplary diagram illustrating an index structure in accordance with one illustrative embodiment. As shown in FIG. 5, the index structure 500 includes entries, such as entry 510, for each Web page of a Website. The entries have an index key 520 and a listing 530 of the references included in the corresponding Web page. The listing of references 530 may be used to identify which Web pages have references to Web page content, e.g., files, that are modified by a user using a Website editor. The index key 520 corresponding to the entries that are identified as having references to Web page content that is modified may be used to identify the Web pages that need to be modified to reflect the modifications to the Web page content, as previously discussed above. The index key 520 may further be used to identify entries in the index data structure 500 that need to be updated based on changes to references in a corresponding Web page.

Thus, by way of the index data structure 452 and the Website reference monitor 460, references to invalid or obsolete Web page content may be identified and automatically corrected so as to avoid having a user access a obsolete reference or the wrong Web page content. In addition, these mechanisms may reduce the network traffic by marking the obsolete or invalid references, or removing the obsolete or invalid references, such that they are not rendered by a Web browser of a client device 490 or otherwise rendered such that they are not selectable by a user. In this way, a user is not able to select the reference to initiate a request for the obsolete or invalid Web page content. As a result, the network traffic associated with requesting obsolete or invalid Web page content is reduced.

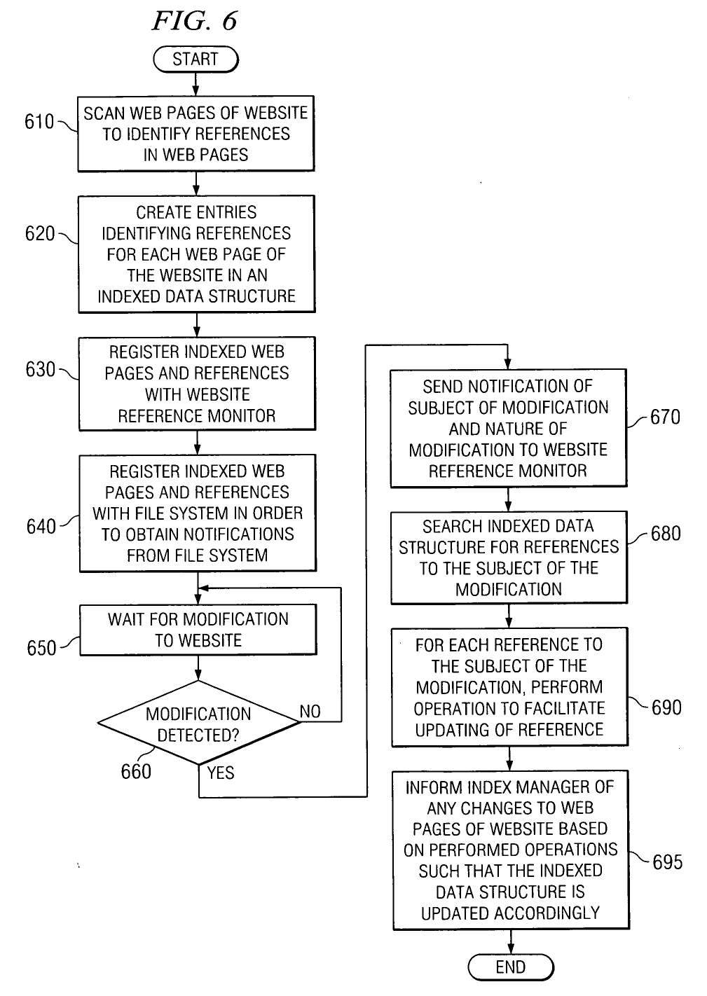

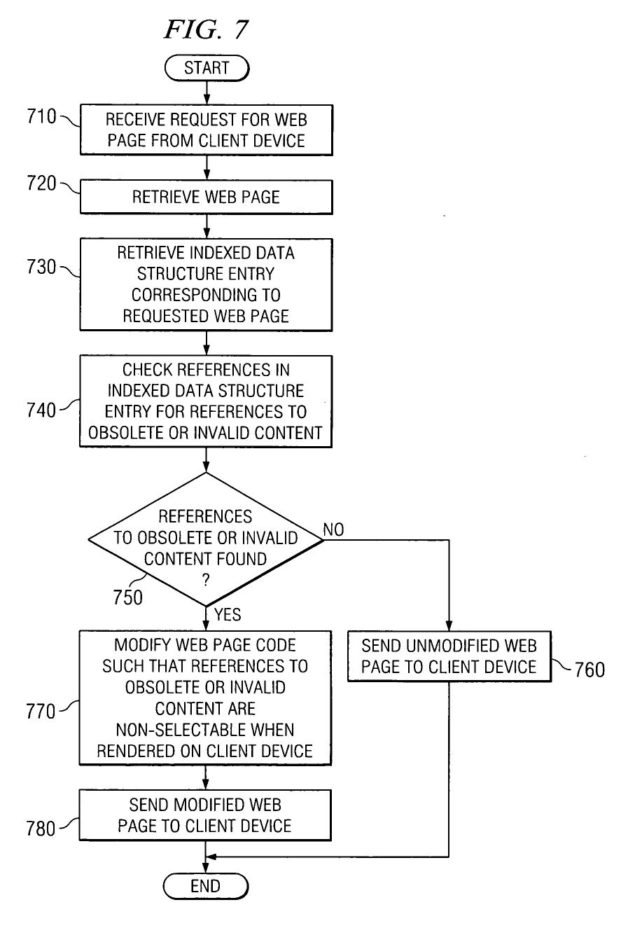

FIGS. 6 and 7 outline exemplary operations in accordance with illustrative embodiments of the present invention. It will be understood that each block of the flowchart illustrations, and combinations of blocks in the flowchart illustrations, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems which perform the specified functions or steps, or by combinations of special purpose hardware and computer instructions.

FIG. 6 is a flowchart outlining an exemplary operation for scanning websites for obsolete Web page references and for auto-correcting Web page references in accordance with one illustrative embodiment. As shown in FIG. 6, the operation starts by scanning Web pages of a Website to identify references present in the Web pages (step 610). Entries for each Web page of the Website are created in an indexed data structure identifying the Web page and the references present in the Web page (step 620). The operation then registers the indexed Web pages and references with a Website reference monitor (step 630). The Website reference monitor registers the indexed Web pages and references with the file system such that modifications to the Web pages, directories, and reference files will be notified to the Website reference monitor (step 640).

The operation then waits for a modification to a file, directory, or Web page of the Website (step 650). A determination is made as to whether a modification is detected (step 660). If not, the operation returns to step 650 and continues to wait. If a modification is detected, a notification of the subject of the modification and the nature of the modification is provided to the Website reference monitor (step 670). The Website reference monitor then searches the indexed data structure for references to the subject of the modification (step 680).

For each reference to the subject of the modification found in the indexed data structure, the Website reference monitor performs an operation corresponding to a profile identifying the operations to perform when references to modified contents of the Website are identified (step 690). Such operations may include updating code of the Web pages corresponding to the identified references based on the nature of the modification, reporting the Web pages that need to be modified to an administrator, and the like. The index manager is then informed of the changes, if any, to the structure of the Website such that the indexed data structure is updated (step 695). The operation then terminates.

FIG. 7 is a flowchart outlining an exemplary operation for handling a client request in accordance with one illustrative embodiment. As shown in FIG. 7, the operation starts by receiving the request for a Web page from a client device (step 710). The Web page is retrieved (step 720) and a corresponding indexed data structure entry is retrieved (step 730). The references identified in the indexed data structure entry are checked to determine if any of the references are to obsolete or invalid content, e.g., files (step 740).

A determination is made as to whether obsolete or invalid content is found (step 750). If not, the Web page is sent to the client device without modification (step 760). If obsolete or invalid content is found, the code of the Web page is modified to make such references to the obsolete or invalid content non-selectable when rendered by a Web browser on the client device (step 770). The modified Web page is then sent to the client device (step 780) and the operation terminates.

Thus, by operation of the mechanisms of the illustrative embodiments, obsolete or invalid references in Web pages of a Website may be automatically identified and modified prior to the Web pages being accessed by a user of a client device. In addition, the mechanisms of the illustrative embodiments provide an automated way to update references to modified content throughout a Website. This helps in reducing the frustration level of users of client devices when accessing obsolete or invalid links to Website content and helps Webmasters or administrators in identifying the portions of the Website that need to be modified when content of the Website that is referenced by these portions is modified. Furthermore, by reducing the occurrence of obsolete or invalid references in Websites, the illustrative embodiments reduce unnecessary network traffic.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer program product comprising a computer useable medium having a computer readable program, wherein the computer readable program, when executed on a computing device, causes the computing device to:
generate an indexed data structure identifying Web pages of the Website and references to content that are present in the Web pages of the Website;
receive a modification to content of the Website;
search the indexed data structure to identify one or more Web pages of the Website that contain references to the modified content of the Website; and
perform at least one operation based on the identification of the one or more Web pages of the Website that contain references to the modified content, wherein the at least one operation facilitates updating of the references to the modified content in the identified one or more Web pages of the Website.

2. The computer program product of claim 1, wherein the at least one operation comprises automatically updating code of the identified one or more Web pages to change a reference to the modified content.

3. The computer program product of claim 1, wherein the at least one operation comprises reporting the identified one or more Web pages having references to the modified content to an administrator.

4. The computer program product of claim 1, wherein the at least one operation comprises marking the references to the modified content in the identified one or more Web pages such that they are not rendered by Web browsers of client devices in a manner that is selectable by a user.

5. The computer program product of claim 1, wherein the computer readable program causes the computing device to perform at least one operation based on the identification of the one or more Web pages of the Website that contain references to the modified content by:
retrieving a preferences profile identifying the at least one operation that is to be performed in response to an identification of one or more Web pages containing references to modified content; and
performing the at least one operation based on the at least one operation identified in the preferences profile.

6. The computer program product of claim 1, wherein the computer readable program causes the computing device to generate an indexed data structure by:
searching each Web page of the Website for references to content contained in each Web page; and
generating an entry in the indexed data structure for each Web page of the Website, wherein the entry is indexed by an identifier of the Web page and contains a listing of each reference to content contained in the corresponding Web page.

7. The computer program product of claim 1, wherein the references to content comprise one or more of hyperlinks, uniform resource locators (URLs), references to image files, references to graphics files, references to sound files, or references to video files.

8. The computer program product of claim 1, wherein the computer readable program further causes the computing device to:
register the indexed data structure with a Website reference monitor;
parse the indexed data structure to identify references to content identified in the indexed data structure; and
generate a monitor list comprising a list of the references to content identified in the indexed data structure that are to be monitored, wherein the modification to content of the Website is received based on a modification to content of the Website matching an entry in the monitor list.

9. The computer program product of claim 8, wherein the computer readable program further causes the computing device to:
register the monitor list with a file system of a server computing device hosting the Website, wherein the file system notifies the Website reference monitor of modifications to content corresponding to the references to content listed in the monitor list.

10. The computer program product of claim 1, wherein the computer readable program further causes the computing device to:
update the indexed data structure based on results of performing the at least one operation.

11. The computer program product of claim 1, wherein the computer readable program further causes the computing device to:
receive a request for a Web page from a client device;
search the indexed data structure for an entry corresponding to the requested Web page;
check references to content identified in the entry of the indexed data structure corresponding to the requested Web page to identify one or more references to obsolete or invalid content;
modify the one or more references to obsolete or invalid content in code of the requested Web page to generate modified code for the requested Web page; and
provide the modified code for the request Web page to the client device.

12. The computer program product of claim 11, wherein the computer readable program causes the computing device to check references to content identified in the entry of the indexed data structure by:
retrieving information, from a file system of a server computing device hosting the Web page, for those references to content that identify locally stored Web page content; and
sending requests to remotely located computing devices hosting content associated with those references to content that identify remotely stored Web page content.

13. The computer program product of claim 12, wherein the computer readable program causes the computing device to identify a reference to content to be a reference to obsolete or invalid content if the file system identifies the Web page content associated with the reference to be not present in a local storage system of the server computing device and registered with the file system or if a request for the Web page content corresponding to the reference sent to a remote computing device results in an error message being returned.

14. A system for updating a Website, comprising:
a processor; and
a memory coupled to the processor, wherein the memory contains instructions that, when executed by the processor, implement an index manager and a Website reference monitor, wherein the index manager generates an indexed data structure identifying Web pages of the Website and references to content that are present in the Web pages of the Website, and wherein the Website reference monitor:
receives a modification to content of the Website;
searches the indexed data structure to identify one or more Web pages of the Website that contain references to the modified content of the Website; and
performs at least one operation based on the identification of the one or more Web pages of the Website that contain references to the modified content, wherein the at least one operation facilitates updating of the references to the modified content in the identified one or more Web pages of the Website.

15. The system of claim 14, wherein the at least one operation comprises automatically updating code of the identified one or more Web pages to change a reference to the modified content.

16. The system of claim 14, wherein the at least one operation comprises reporting the identified one or more Web pages having references to the modified content to an administrator.

17. The system of claim 14, wherein the at least one operation comprises marking the references to the modified content in the identified one or more Web pages such that they are not rendered by Web browsers of client devices in a manner that is selectable by a user.

18. The system of claim 14, wherein the Website reference monitor performs at least one operation based on the identification of the one or more Web pages of the Website that contain references to the modified content by:
retrieving a preferences profile identifying the at least one operation that is to be performed in response to an identification of one or more Web pages containing references to modified content; and
performing the at least one operation based on the at least one operation identified in the preferences profile.

19. The system of claim 14, wherein the index manager generates an indexed data structure by:
searching each Web page of the Website for references to content contained in each Web page; and
generating an entry in the indexed data structure for each Web page of the Website, wherein the entry is indexed by an identifier of the Web page and contains a listing of each reference to content contained in the corresponding Web page.

20. The system of claim 14, wherein the references to content comprise one or more of hyperlinks, uniform resource locators (URLs), references to image files, references to graphics files, references to sound files, or references to video files.

21. The system of claim 14, wherein the index manager registers the indexed data structure with a Website reference monitor, and wherein the Website reference monitor:
parses the indexed data structure to identify references to content identified in the indexed data structure; and
generates a monitor list comprising a list of the references to content identified in the indexed data structure that are to be monitored, wherein the modification to content of the Website is received based on a modification to content of the Website matching an entry in the monitor list.

22. The system of claim 21, wherein the Website reference monitor registers the monitor list with a file system of a server computing device hosting the Website, and wherein the file system notifies the Website reference monitor of modifications to content corresponding to the references to content listed in the monitor list.

23. The system of claim 14, wherein the index manager updates the indexed data structure based on results of performing the at least one operation.

24. The system of claim 14, wherein the instructions further implement a obsolete/invalid reference identification and correction engine, and wherein the obsolete/invalid reference identification and correction engine:
receives a request for a Web page from a client device;
searches the indexed data structure for an entry corresponding to the requested Web page;
checks references to content identified in the entry of the indexed data structure corresponding to the requested Web page to identify one or more references to obsolete or invalid content;
modifies the one or more references to obsolete or invalid content in code of the requested Web page to generate modified code for the requested Web page; and
provides the modified code for the request Web page to the client device.

25. The system of claim 24, wherein the obsolete/invalid reference identification and correction engine checks references to content identified in the entry of the indexed data structure by:
retrieving information, from a file system of a server computing device hosting the Web page, for those references to content that identify locally stored Web page content; and
sending requests to remotely located computing devices hosting content associated with those references to content that identify remotely stored Web page content.

26. The system of claim 25, wherein the obsolete/invalid reference identification and correction engine identifies a reference to content to be a reference to obsolete or invalid content if the file system identifies the Web page content associated with the reference to be not present in a local storage system of the server computing device and registered with the file system or if a request for the Web page content corresponding to the reference sent to a remote computing device results in an error message being returned.

27. A method, in a data processing system, for updating a Website, comprising:
generating an indexed data structure identifying Web pages of the Website and references to content that are present in the Web pages of the Website;
receiving a modification to content of the Website;
searching the indexed data structure to identify one or more Web pages of the Website that contain references to the modified content of the Website; and
performing at least one operation based on the identification of the one or more Web pages of the Website that contain references to the modified content, wherein the at least one operation facilitates updating of the references to the modified content in the identified one or more Web pages of the Website.

28. The method of claim 27, wherein the at least one operation comprises at least one of automatically updating code of the identified one or more Web pages to change a reference to the modified content, reporting the identified one or more Web pages having references to the modified content to an administrator, or marking the references to the modified content in the identified one or more Web pages such that they are not rendered by Web browsers of client devices in a manner that is selectable by a user.

29. The method of claim 27, wherein performing at least one operation based on the identification of the one or more Web pages of the Website that contain references to the modified content comprises:
retrieving a preferences profile identifying the at least one operation that is to be performed in response to an identification of one or more Web pages containing references to modified content; and
performing the at least one operation based on the at least one operation identified in the preferences profile.

30. The method of claim 27, wherein generating an indexed data structure comprises:
searching each Web page of the Website for references to content contained in each Web page; and
generating an entry in the indexed data structure for each Web page of the Website, wherein the entry is indexed by an identifier of the Web page and contains a listing of each reference to content contained in the corresponding Web page.

31. The method of claim 27, further comprising:
registering the indexed data structure with a Website reference monitor;
parsing the indexed data structure to identify references to content identified in the indexed data structure; and
generating a monitor list comprising a list of the references to content identified in the indexed data structure that are to be monitored, wherein the modification to content of the Website is received based on a modification to content of the Website matching an entry in the monitor list.

32. The method of claim 31, further comprising:
registering the monitor list with a file system of a server computing device hosting the Website, wherein the file system notifies the Website reference monitor of modifications to content corresponding to the references to content listed in the monitor list.

33. The method of claim 27, further comprising updating the indexed data structure based on results of performing the at least one operation.

34. The method of claim 27, further comprising:
receiving a request for a Web page from a client device;
searching the indexed data structure for an entry corresponding to the requested Web page;
checking references to content identified in the entry of the indexed data structure corresponding to the requested Web page to identify one or more references to obsolete or invalid content;
modifying the one or more references to obsolete or invalid content in code of the requested Web page to generate modified code for the requested Web page; and
providing the modified code for the request Web page to the client device.

35. The computer program product of claim 11, wherein checking references to content identified in the entry of the indexed data structure comprises:
retrieving information, from a file system of a server computing device hosting the Web page, for those references to content that identify locally stored Web page content; and
sending requests to remotely located computing devices hosting content associated with those references to content that identify remotely stored Web page content.
